(19) United States
(12) Patent Application Publication
(10) Pub. No.: US 2015/0215404 A1
(43) Pub. Date: Jul. 30, 2015

(54) REPLICATION DEVICE, REPLICATION METHOD, AND REPLICATION SYSTEM

(71) Applicant: FUJITSU LIMITED, Kawasaki-shi (JP)

(72) Inventor: Toshihiro Ozawa, Yokohama (JP)

(21) Appl. No.: 14/559,374

(22) Filed: Dec. 3, 2014

(30) Foreign Application Priority Data
Jan. 27, 2014 (JP) 2014-012449

(51) Int. Cl. H04L 29/08

(52) U.S. Cl. CPC H04L 67/1097

(57) ABSTRACT

A replication device includes: a memory configured to store a replication program; and a CPU configured to execute the replication program, wherein the CPU, based on the replication program, performs operations: determining an arrangement, as a first arrangement of a first replica of first data to a storage node, so that the first data are distributed and stored to and in a plurality of first storage nodes; and determining an arrangement, as a second arrangement of a second replica of second data to the storage node, so that the second data is continuously stored in a second storage node that is different from the plurality of first storage nodes.

### CROSS-REFERENCE TO RELATED APPLICATION

This application is based upon and claims the benefit of priority of the prior Japanese Patent Application No. 2014-012449, filed on Jan. 27, 2014, the entire contents of which are incorporated herein by reference.

### FIELD

The embodiments discussed herein are related to a replication device, a replication method, and a replication system.

### BACKGROUND

A data distribution method in which data is distributed and stored to and in a plurality of servers as storage nodes includes a consistent hash method. In the consistent hash method, hash values are obtained for each of the servers and each of the data by a hash function that has been prepared beforehand. For example, the numeric values from an IP address of the server and the name of the data are calculated as hash values. The range of the hash function is represented as a hash space having a ring form.

Related arts have been discussed in Japanese Laid-open Patent Publication No. 2010-271798, Japanese Laid-open Patent Publication No. 2007-133503, or Japanese National Publication of International Patent Application No. 2012-524947.

### SUMMARY

According to an aspect of the embodiments, a replication device includes: a memory configured to store a replication program; and a CPU configured to execute the replication program, wherein the CPU, based on the replication program, performs operations: determining an arrangement, as a first arrangement of a first replica of first data to a storage node, so that the first data are distributed and stored to and in a plurality of first storage nodes; and determining an arrangement, as a second arrangement of a second replica of second data to the storage node, so that the second data is continuously stored in a second storage node that is different from the plurality of first storage nodes.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a hash space having a ring form;

FIG. 2 illustrates an example of a distribution storage;

FIG. 3 illustrates an example of replica arrangement;

FIG. 4 illustrates an example of a function configuration of a replication device;

FIGS. 5A to 5C illustrate an example of an increase in a number of lines;

FIG. 6 illustrates an example of arrangement processing of a replica;

FIG. 7 illustrates an example of read processing; and

FIG. 8 is a diagram illustrating an example of a hardware configuration of a computer.

### DESCRIPTION OF EMBODIMENTS

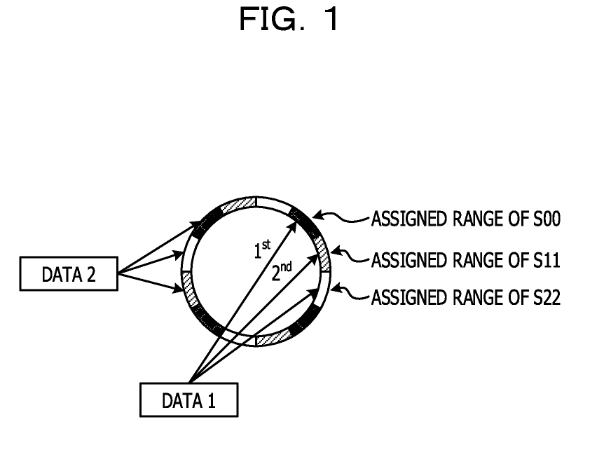

FIG. 1 illustrates an example of a hash space having a ring form. In FIG. 1, a certain server takes charge of data having hash values of a certain range on a ring. For example, “server S00” takes charge of data indicated by a range marked as black, and “server S11”, takes charge of data indicated by a shaded range.

In the arrangement of the data, the position on the ring is obtained from a hash value of the name of the data, a server that takes charge of the data is determined, and a first replication (1^{st} replica) is arranged in the determined server. A second replication (2^{nd} replica) is arranged, for example, in a server that takes charge of the next area in a clockwise direction on the ring (“server S11” in the case of “data 1”).

The 2^{nd} replica may be arranged in an area other than the next area in the clockwise direction on the ring. In the plurality of replicas, even when a certain server breaks down, access to the data is allowed. Therefore, the arrangement of the 2^{nd} replica is selected so that the two replicas are not arranged in an identical server. For example, a hash value of the 1^{st} replica is obtained from the name of the data, and a hash value of the 2^{nd} replica is obtained from a different value to determine arrangement of servers for the replicas on the same ring. In this case, the two hash values are in an identical assigned range, and the replicas may be arranged in an identical server.

For example, when the server in which the two replicas are arranged breaks down, accesses to the two replicas are not allowed, so that the data may be lost. A way to obtain a hash value includes, for example, a way to obtain a hash value from the reversed name, or a way to obtain a hash value from the value of the data in addition to the way to obtain a hash value from the name of data.

For example, in a distribution data management system in which a plurality of replicas is stored, the data is written to a node that is selected based on a value that has been obtained from the value of the data, and the data is written to a node that is selected based on a value that has been obtained from metadata.

In addition, the replica of data that is to be requested from a data request side is generated and accumulated beforehand in a data accumulation area of a specified range in a distribution system. When the request is received from the data request side, a response is performed using the replica. In addition, the arrangement of the replica is determined based on a feature such as the capacity, data storage cost, or the location of the storage node.

The consistent hash method has a characteristic by which data is distributed approximately evenly by hashing the names of the data using a hash function. The replica is arranged in a server that takes charge of the next area on the ring, so that the replicas are distributed approximately evenly.

On the other hand, in the usage of data, there are a case in which a series of data is arranged in a lot of servers, and a case in which the series of data is arranged to a few servers. For example, in a case in which a movie is divided into data A, data B, . . . , when the movie is reproduced, the data is read in order, so that it is desirable that the series of data is arranged collectively in a single server. On the other hand, in a case of analysis of movie (such as check of distribution of colors), it is desirable that the series of data is arranged in a lot of servers to read the series of data in parallel and process the series of data at high speed.

As described above, depending on the usage of the data, there are the case in which it is desirable the data are distributed to a lot of servers and the case in which the data are put together in a few servers. The usage of the data is changed depending on processing, so that the data arrangement may not be determined beforehand. In addition, replicas of identical data may not be stored in an identical server.

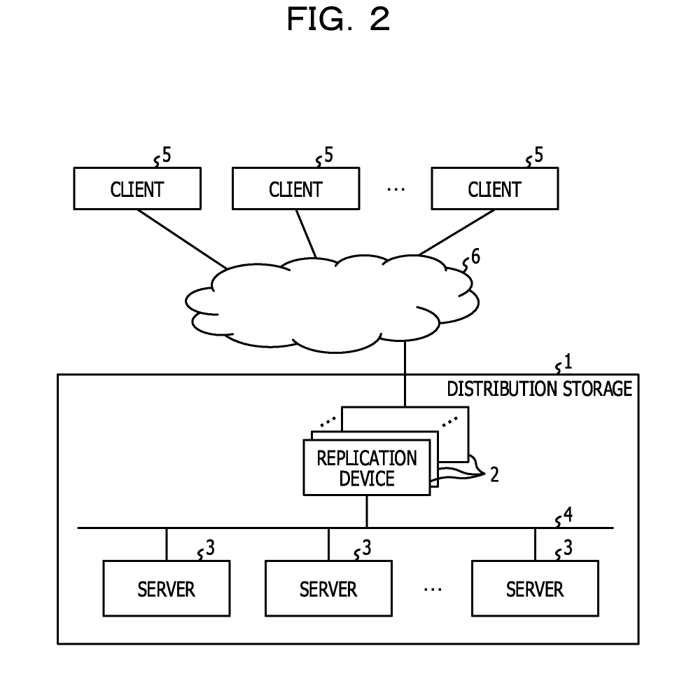

FIG. 2 illustrates an example of a distribution storage. As illustrated in FIG. 2, a distribution storage 1 includes a plurality of replication devices 2 and a plurality of servers 3.

The replication device 2 is a device that accepts a data access request from a client 5, which is used for an access of the distribution storage 1 by a user of the distribution storage 1, through the Internet 6. When the replication device 2 accepts a data write request from the client 5, the replication device 2 transfers two replicas of the data to different servers 3.

When the replication device 2 accepts a data read request from the client 5, the replication device 2 reads the data from one of the two servers 3 that store the replicas of the data, and transmits the data to the client 5. The replication device 2 and the client 5 may correspond to each other so as to be one to one.

The server 3 is a storage node in which the replica of data is stored in a hard disk drive (HDD). The plurality of replication devices 2 are coupled to the plurality of servers 3 through a local area network (LAN) 4, but may be coupled to the plurality of servers 3 through a further network. The replication devices 2 may communicate with each other.

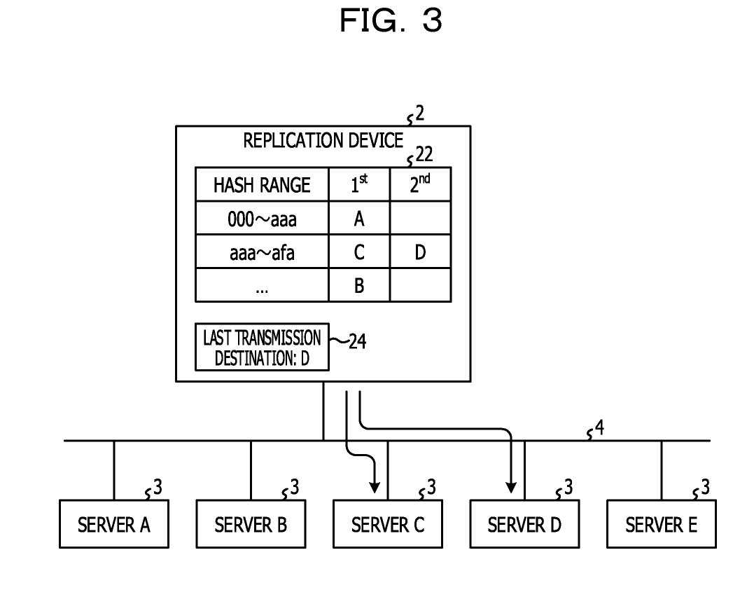

FIG. 3 illustrates an example of replica arrangement. FIG. 3 illustrates the replica arrangement by the distribution storage 1 illustrated in FIG. 2. As illustrated in FIG. 2, the replication device 2 includes a data distribution table 22 that is used for arrangement of replicas and a last transmission destination storage unit 24 that stores the identifier of a server 3 that is a last transmission destination of a 2^{nd} replica.

The replication device 2 arranges the 1^{st} replica in a server 3 that has been selected based on a hash value of the data from among servers 3 the identifiers of which are stored in the 1^{st} column of the data distribution table 22. The replication device 2 arranges the 2^{nd} replica in a server 3 the identifier of which is stored in the last transmission destination storage unit 24, and stores the identifier of the server 3 of the transmission destination, in the 2^{nd} column of the data distribution table 22.

When the server 3 the identifier of which is stored in the last transmission destination storage unit 24 is the same as the server 3 in which the 1^{st} replica has been arranged, the replication device 2 arranges the 2^{nd} replica in the server 3 that is next to the last transmission destination on the ring that indicates the hash space. The replication device 2 updates the last transmission destination storage unit 24 with the identifier of the server 3 in which the 2nd replica has been arranged, and stores the identifier of the sever 3 of the transmission destination in the 2^{nd} column of the data distribution table 22.

For example, when a hash value that has been calculated from data is “abc”, the replication device 2 arranges the 1^{st} replica in “server C” the identifier “C” of which is stored in the 1^{st} column of the data distribution table 22. The replication device 2 arranges the 2^{nd} replica in “server D” the identifier “D” of which is stored in the last transmission destination storage unit 24, and stores the identifier “D” of the server 3 of the transmission destination in the 2^{nd} column of the data distribution table 22.

As described above, the replication device 2 arranges the 1^{st} replica in a server 3 that has been selected based on a hash value of the data. The replication device 2 distributes and arranges the series of data to and in a lot of servers 3 using the 1^{st} replicas. Therefore, for example, in movie analysis such as check of colors, in the distribution storage 1, data may be read at high speed by reading the data in parallel.

The replication device 2 arranges the 2^{nd} replica in the last transmission destination of the data. The replication device 2 arranges the series of data in an identical server 3 using the 2^{nd} replicas. Therefore, for example, in a case such as reproduction of a movie that has been divided into a plurality of files and stored in the distribution storage 1, in the distribution storage 1, the series of files are read from the identical server 3 at high speed.

When the last transmission destination is the same as the arrangement destination of the 1^{st} replica, the replication device 2 arranges the 2^{nd} replica in the server 3 that is next to the last transmission destination on the ring that indicates the hash space. Therefore, the replication device 2 respectively arranges the 1^{st} replica and the 2^{nd} replica in the different servers 3.

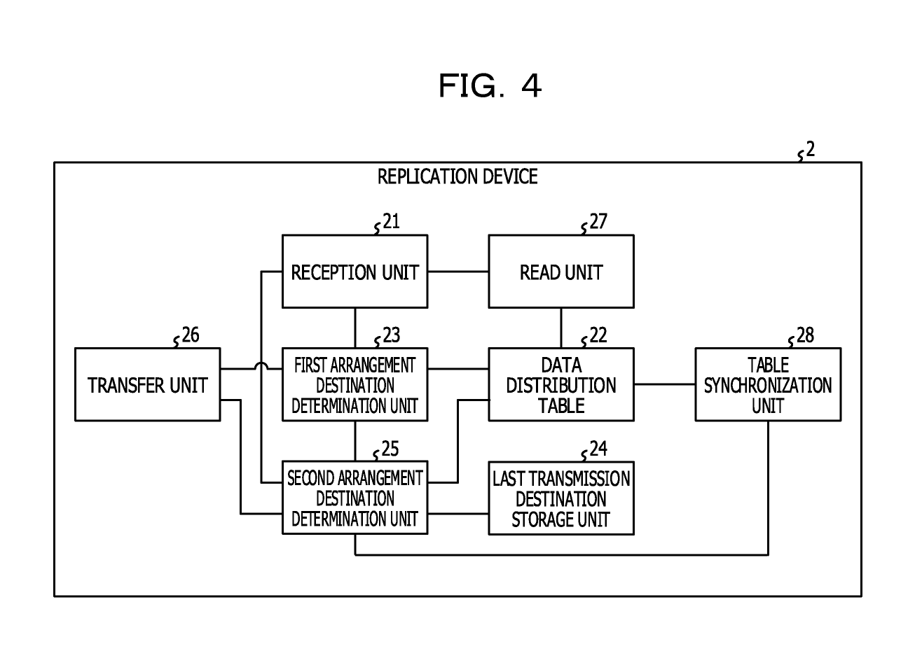

FIG. 4 illustrates an example of a function configuration of a replication device. As illustrated in FIG. 4, the replication device 2 includes a reception unit 21, a data distribution table 22, a first arrangement destination determination unit 23, a last transmission destination storage unit 24, a second arrangement destination determination unit 25, a transfer unit 26, a read unit 27, and a table synchronization unit 28.

The reception unit 21 receives an access request to the distribution storage 1, from the client 5. The reception unit 21 passes the access request to the first arrangement destination determination unit 23 and the second arrangement destination determination unit 25 when the access request is a data write request, and passes the access request to the read unit 27 when the access request is a data read request.

The data distribution table 22 is a table that is used to determine an arrangement destination of a replica, associates a hash range with the identifier of a server 3 that is an arrangement destination of the replica and stores the associated hash range and the identifier. For example, in FIG. 3, the data distribution table 22 stores values of “1^{st}” and “2^{nd}” for each hash range. Here, “1^{st}” indicates the identifier of a server 3 that is an arrangement destination of the 1^{st} replica, and “2^{nd}” indicates the identifier of a server 3 that is an arrangement destination of the 2^{nd} replica. “1^{st}” indicates an arrangement destination that is statically determined from the hash range, and “2^{nd}” indicates an arrangement destination that is dynamically determined from the hash range, the last transmission destination, or the like. An initial value of “2^{nd}” may be empty.

In FIG. 3, the data distribution table 22 stores “A” that is statically determined as the identifier of a server 3 that is an arrangement destination of the 1^{st} replica by associating “A” with a hash range “000 to aaa”. The identifier of a server 3 that is an arrangement destination of the 2^{nd} replica is not stored at that time. The data distribution table 22 stores “C” that is statically determined as the identifier of a server 3 that is an arrangement destination of the 1^{st} replica and stores “D” that is dynamically determined as the identifier of a server 3 that is an arrangement destination of the 2^{nd} replica by associating “C” and D″ with a hash range “aaa to afa”.

The data distribution table 22 stores information that is identical among the plurality of replication devices 2. Therefore, the information of the data distribution table 22 is synchronized among the replication devices 2. In the data distribution table 22, the number of lines is greatly large as compared with the number of servers, and for example, may be around 10 000 times the number of servers.

The first arrangement destination determination unit 23 receives a data write request from the reception unit 21, and calculates a hash value from the write data. The first arrangement destination determination unit 23 determines an arrangement destination of the 1^{st} replica based on the hash value and the data distribution table 22, and passes the determined arrangement destination to the transfer unit 26 with the write data.

The last transmission destination storage unit 24 stores the identifier of a server 3 that is a last transmission destination of the 2^{nd} replica. The replication device 2 corresponds to the client 5 on a one-to-one basis, so that the last transmission destination storage unit 24 stores the identifier of the server 3 that is the last transmission destination for the corresponding client 5. An initial value of the last transmission destination storage unit 24 may be determined randomly.

The second arrangement destination determination unit 25 receives the data write request from the reception unit 21, and calculates a hash value from the write data. The second arrangement destination determination unit 25 determines an arrangement destination of the 2^{nd} replica based on the hash value, the data distribution table 22, and the last transmission destination storage unit 24, and passes the determined arrangement destination to the transfer unit 26 with the write data.

The second arrangement destination determination unit 25 determines the arrangement destination so that the 2^{nd} replicas of the series of data that are written from the client 5 are arranged in an identical server 3. For example, when the 2^{nd} column in the data distribution table 22, which corresponds to the hash value of the data, is empty, the second arrangement destination determination unit 25 sets a value that is stored in the last transmission destination storage unit 24 to the 2^{nd} column, and arranges the 2^{nd} replica in the last transmission destination. The 2^{nd} replica is arranged in a server 3 to which the previous 2^{nd} replica has been written from the client.

When a value that is stored in the 1^{st} column and a value that is stored in the last transmission destination storage unit 24 are identical to each other, the two replicas are arranged in an identical server 3 undesirably. In a such case, the second arrangement destination determination unit 25 does not write the 2^{nd} replica to a server 3 to which the previous 2^{nd} replica has been written, and changes the value that is stored in the last transmission destination storage unit 24, to a value that is moved by one in the clockwise direction on the ring that indicates the hash space.

When a value of the 2^{nd} column in the data distribution table 22, which corresponds to the hash value of the data, is identical to a value that is stored in the last transmission destination storage unit 24, the second arrangement destination determination unit 25 arranges the 2^{nd} replica in the server 3 that is indicated by the last transmission destination storage unit 24. When the value of the 2^{nd} column is identical to the value that is stored in the last transmission destination storage unit 24, the values of the 1^{st} column and the 2^{nd} column are not equal due to processing that has been executed until that time.

When the 2^{nd} column in the data distribution table 22, which corresponds to the hash value of the data, is not empty, and is not identical to the value that is stored in the last transmission destination storage unit 24, the second arrangement destination determination unit 25 may not write the 2^{nd} replica to the server to which the previous 2^{nd} has been written. Therefore, the second arrangement destination determination unit 25 tries to divide, a certain maximum number of times (for example, 10 times) an assigned range of a line that corresponds to the hash value of the data distribution table 22 into a plurality of lines.

For example, the second arrangement destination determination unit 25 divides the line that corresponds to the hash value into n (for example, 100) lines. The second arrangement destination determination unit 25 asks a server 3 that has held the 2^{nd} replica until that time (server 3 that is indicated in the 2^{nd} column) about whether data that corresponds to which line from among increased lines is held. The second arrangement destination determination unit 25 sets the value that has been indicated in the 2^{nd} column before the division, to the 2^{nd} column of the line that is replied from the server 3 that has held the 2^{nd} replica. Therefore, the 2^{nd} column in the data distribution table 22, which corresponds to the hash value of the data, becomes empty, and the 2^{nd} replica may be arranged in the server 3 that is the same as the last transmission destination.

In a case in which the 2^{nd} column does not become empty even when the assigned range is tried to be divided by the certain maximum number of times, the second arrangement destination determination unit 25 may stop writing the 2^{nd} replica to the server 3 to which the previous 2^{nd} replica has been written. The second arrangement destination determination unit 25 arranges the data in the server that is indicated by the 2^{nd} column, and updates the last transmission destination storage unit 24 with an identifier of the server 3.

As described above, the second arrangement destination determination unit 25 does not determine an arrangement destination of the 2^{nd} replica beforehand, and may determine the arrangement destination of the 2^{nd} replica in the process of accumulating data. Therefore, by the distribution storage 1, arrangement of a new 2^{nd} replica is performed appropriately depending on the arrangement status of the 2^{nd} replica.

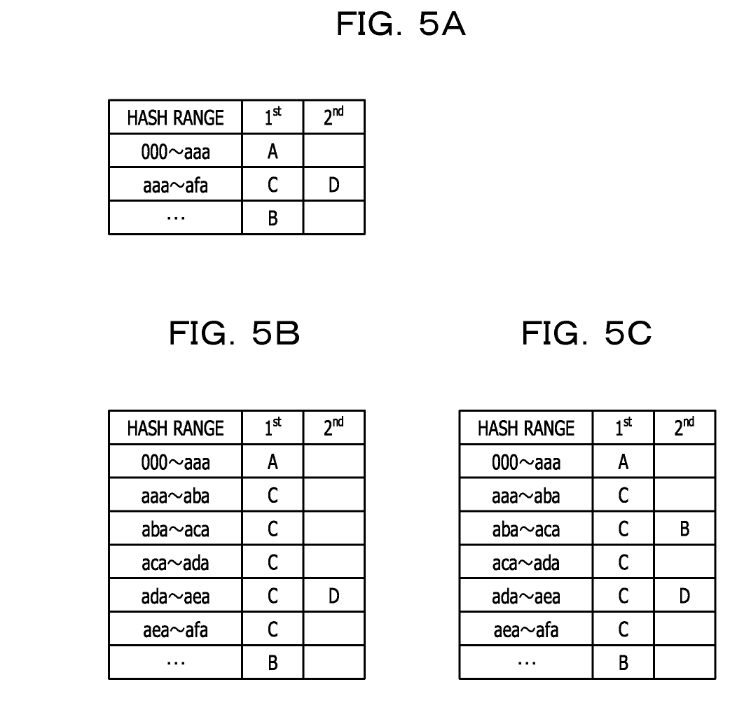

FIGS. 5A to 5C illustrate an example of an increase in a number of lines. In FIGS. 5A to 5C, the second arrangement destination determination unit 25 increases the number of lines of the data distribution table 22. For example, when data Y the hash value of which is “ada” has been already written, and the data distribution table 22 may be in the state illustrated in FIG. 5A. A hash range “ppp to qqq” indicates that the hash value is “ppp” or more and less than “qqq”.

At that time, when the replication device 2 in which the value of the last transmission destination storage unit 24 is “B” writes data X the hash value of which is “abc”, the second line from the hash range of the data distribution table 22 takes charge of the hash value “abc” of the data X. Thus, the 1^{st} replica is arranged in a server C based on a value “C” of the 1^{st} column of the second line of FIG. 5A.

The 2^{nd} column of the second line of the data distribution table 22 corresponds to “D”, and is not empty and is not equal to “B” that is the value stored in the last transmission destination storage unit 24. Therefore, the second arrangement destination determination unit 25 increases the number of lines of the data distribution table 22. For example, the second arrangement destination determination unit 25 increases lines by four.

The second arrangement destination determination unit 25 asks a server D about whether the identifier of the 2^{nd} column is to be set to which line from among the increased number of lines because the identifier of the server 3 that has the data that corresponds to the original 2^{nd} replica of the second line is “D”. Here, “D” is set to the 2^{nd} column of the line that has been replied from the server D.

FIG. 5B illustrates an update result of the data distribution table 22 by the second arrangement destination determination unit 25. As illustrated in FIG. 5B, the data Y the hash value of which is “ada” is managed in the fifth line of the data distribution table 22 in which the number of lines is increased, so that the 2^{nd} column of the fifth line corresponds to “D”. The 2^{nd} replica that corresponds to the other increased lines does not exist, so that the 2^{nd} columns that correspond to the other increased lines may become empty.

In the data distribution table 22 illustrated in FIG. 5B, the third line takes charge of the hash value “abc” of data X. The 2^{nd} column of the third line is empty. The second arrangement destination determination unit 25 sets a server B to which the previous 2^{nd} replica has been written, which is indicated by the last transmission destination storage unit 24, as an arrangement destination of the 2^{nd} replica, and updates the data distribution table 22 as illustrated in FIG. 5C.

Returning to FIG. 4, the transfer unit 26 receives data and transmission destination specification of the data from the first arrangement destination determination unit 23 or the second arrangement destination determination unit 25, and transmits the data to the specified transmission destination server 3.

The read unit 27 receives a data read request from the reception unit 21, and identifies a server 3 from which the of data is read. In the data read request, whether or not the data is wanted to be read from an identical server 3 is specified. The read unit 27 identifies a server 3 from which the data are read, based on the specification of whether the data is to be read from an identical server 3 and the data distribution table 22.

For example, the read unit 27 identifies a server 3 from which the data is read, by using the 2^{nd} column of the data distribution table 22 when “the data is wanted to be read from an identical server 3” is specified. When “the data is wanted to be read from the identical server 3” is not specified, the read unit 27 identifies servers 3 from which the data is read, by using the 1^{st} column in the data distribution table 22. The read unit 27 reads the data from the identified servers 3.

The table synchronization unit 28 synchronizes information of the data distribution table 22 with that of a further replication device 2. The table synchronization unit 28 performs synchronization with the further replication device 2 when the number of lines is increased, the 2^{nd} column is updated, or the like.

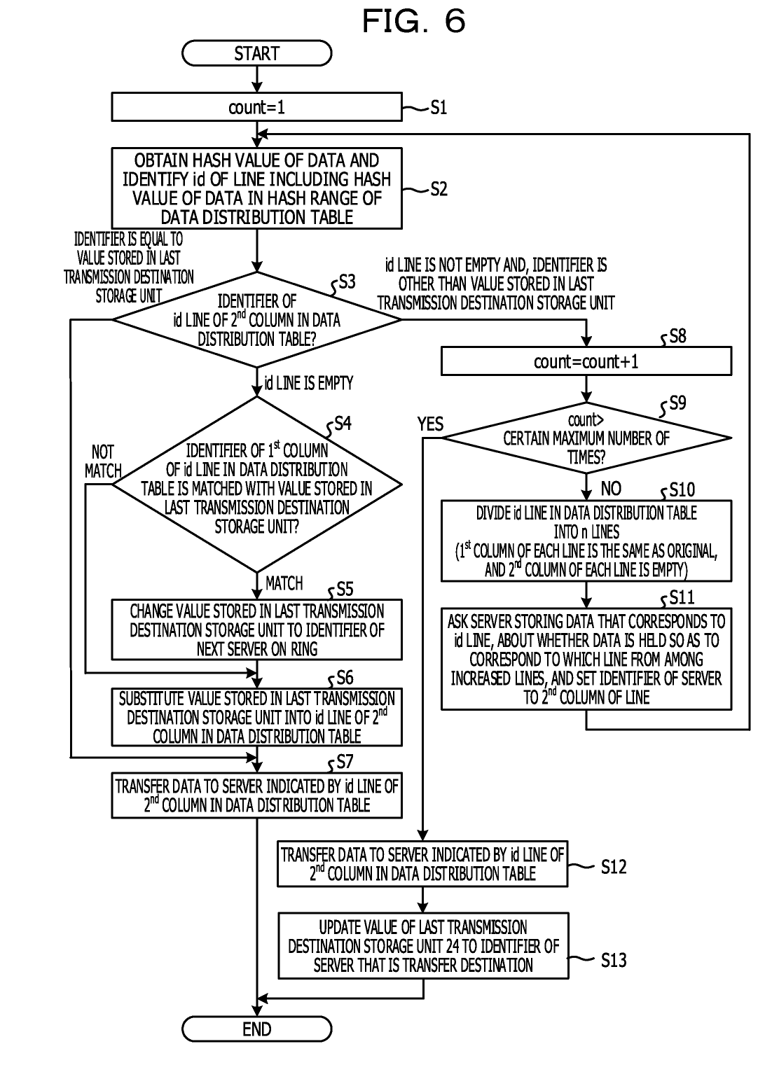

FIG. 6 illustrates an example of arrangement processing of a replica. In FIG. 6, arrangement processing of a 2^{nd} replica is illustrated. As illustrated in FIG. 6, the second arrangement destination determination unit 25 initializes “count” with “1” (Operation S1). Here, “count” may be a counter that is used to count the number of times for dividing a line of the data distribution table 22.

The second arrangement destination determination unit 25 obtains a hash value of data, and identifies “id” of a line in which a hash range of the data distribution table 22 includes the hash value of the data (Operation S2). Here, “id” is the number of the line. The second arrangement destination determination unit 25 determines the identifier of the id line of the 2^{nd} column in the data distribution table 22 (Operation S3).

When the identifier of the id line of the 2^{nd} column in the data distribution table 22 is equal to a value that is stored in the last transmission destination storage unit 24, the transfer unit 26 transfers the data to a server 3 that is indicated by the id line of the 2^{nd} column in the data distribution table (Operation S7).

When the id line of the 2^{nd} column in the data distribution table 22 is empty, the second arrangement destination determination unit 25 determines whether or not the identifier of the 1^{st} column of the id line in the data distribution table 22 is matched with the value that is stored in the last transmission destination storage unit 24 (Operation S4). When the identifier of the 1^{st} column of the id line in the data distribution table 22 is matched with the value that is stored in the last transmission destination storage unit 24, the second arrangement destination determination unit 25 changes the value to the identifier of the next server 3 on the ring (Operation S5). When the identifier of the 1^{st} column of the id line in the data distribution table 22 is not matched with the value that is stored in the last transmission destination storage unit 24, the processing proceeds to Operation S6.

The second arrangement destination determination unit 25 substitute the value that is stored in the last transmission destination storage unit 24, into the id line of the 2^{nd} column in the data distribution table 22 (Operation S6). The transfer unit 26 transfers the data to a server 3 that is indicated by the id line of the 2^{nd} column in the data distribution table 22 (Operation S7).

When the identifier of the id line of the 2^{nd} column in the data distribution table 22 is not equal to the value that is stored in the last transmission destination storage unit 24, and the id line of the 2^{nd} column in the data distribution table 22 is not empty, the second arrangement destination determination unit 25 adds “1” to the count (Operation S8). The second arrangement destination determination unit 25 determines whether or not the value of the count is larger than a certain maximum number of times (Operation S9).

When the value of the count is not larger than the certain maximum number of times, the second arrangement destination determination unit 25 divides the id line of the data distribution table 22, into n lines (Operation S10). For example, “n” may be 100. The 1^{st} column of each of the divided lines is the same as the original, and the 2^{nd} column is empty. For example, in FIG. 5B, “n” is set as 5, and the line of the hash range “aaa to afa” is divided into 5 lines. The 1^{st} column of the each of the divided lines may be “C” that is the same as the 1^{st} column of the original hash range “aaa to afa”.

The second arrangement destination determination unit 25 asks the server 3 that stores the data that corresponds to the id line, about whether the data is held so as to correspond to which line from among the increased lines, and sets the identifier of the server 3 to the 2^{nd} column of a replied line (Operation S11). For example, in FIG. 5B, data Y the hash value of which is “ada” is stored in “server D”, so that the second arrangement destination determination unit 25 asks “server D” about whether the data is stored so as to correspond to which line from among the increased lines. The second arrangement destination determination unit 25 sets “D” to the 2^{nd} column of the fifth line when the fifth line is replied from “server D”. The processing returns to Operation S2. The third line in the data distribution table 22 takes charge of the hash value “abc” of the data X, so that, the second arrangement destination determination unit 25 identifies the id as “3” in Operation S2. In Operation S6, as illustrated in FIG. 5C, the second arrangement destination determination unit 25 substitutes “B” that is stored in the last transmission destination storage unit 24 into the third line in the data distribution table 22.

When the value of the count is larger than the certain maximum number of times, the transfer unit 26 transfers the data to the server 3 that is indicated by the id line of the 2^{nd} column in the data distribution table 22 (Operation S12). The second arrangement destination determination unit 25 updates the value of the last transmission destination storage unit 24 with the identifier of the server 3 that is the transfer destination (Operation S13).

As described above, when the second arrangement destination determination unit 25 determines arrangement of the 2^{nd} replica based on the hash value, the data distribution table 22, and the last transmission destination storage unit 24, the distribution storage 1 may store the series of data in an identical server 3 using the 2^{nd} replicas.

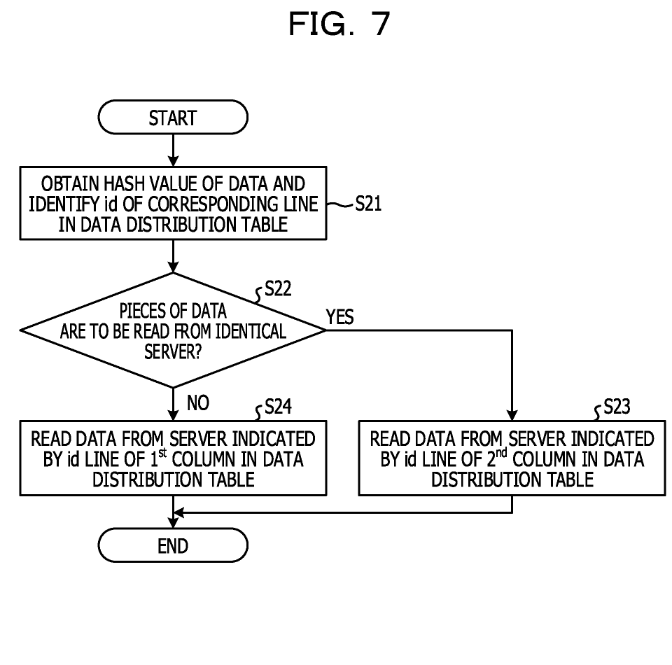

FIG. 7 illustrates an example of read processing. As illustrated in FIG. 7, the read unit 27 obtains a hash value of data, and identifies of an id of the corresponding line in the data distribution table 22 (Operation S21).

The read unit 27 determines whether or not data is wanted to be read from an identical server 3, based on a read request (Operation S22). When “the data is wanted to be read from the identical server 3” is specified, the read unit 27 reads the data from a server 3 that is indicated by the id line of the 2^{nd} column in the data distribution table 22 (Operation S23).

When “the data is wanted to be read from the identical server 3” is not specified, the read unit 27 reads the data from a server 3 that is indicated by the id line of the 1^{st} column in the data distribution table 22 (Operation S24).

As described above, when the read unit 27 reads the 1^{st} replica or the 2^{nd} replica based on the read request, the distribution storage 1 may read the data at high speed using the replica that corresponds to the request from the client 5.

The first arrangement destination determination unit 23 determines an arrangement destination of the 1^{st} replica so that data is distributed and arranged. The second arrangement destination determination unit 25 determines the arrangement of the 2^{nd} replica so that data is continuously stored in an identical server 3, and stored in the server that is different from those of the 1^{st} replicas. Therefore, the distribution storage 1 deals with both a case in which it is desirable that a series of data is arranged in a lot of servers and a case in which it is desirable that a series of data is arranged in a few servers, and replicas of identical data may not be stored in an identical server.

The data distribution table 22 stores the identifiers of servers 3 of arrangement destinations of the 1^{st} replica and the 2^{nd} replica, for each hash range. The last transmission destination storage unit 24 stores the identifier of a server 3 that is a last transmission destination of the 2^{nd} replica. The second arrangement destination determination unit 25 determines an arrangement destination of the 2^{nd} replica, based on a hash value of data, the data distribution table 22, and the last transmission destination storage unit 24. Therefore, the second arrangement destination determination unit 25 may determine the arrangement of the 2^{nd} replica so that data is continuously stored in an identical server 3, and stored in the server that is different from those of the 1^{st} replicas.

When the arrangement destination of the 2^{nd} replica based on the hash value is different from the last transmission destination based on the last transmission destination storage unit 24, the second arrangement destination determination unit 25 tries to match the arrangement destination of the 2^{nd} replica based on the hash value with the last transmission destination based on the last transmission destination storage unit 24 by dividing the hash range. Therefore, the second arrangement destination determination unit 25 may arrange the 2^{nd} replica so that series of data is stored in an identical server 3.

In a case in which the arrangement destination based on the hash value and the last transmission destination are not caused to be matched with each other even when the hash range is divided by the certain number of times, the second arrangement destination determination unit 25 arranges the 2^{nd} replica in the arrangement destination based on the hash value. Therefore, excessive concentration of data on an identical server 3 may be reduced.

The replication device 2 may be obtained by software. A replication program having a function that is similar to that of the replication device 2 is provided. The replication program may be executed by a computer. The computer may execute a plurality of replication programs.

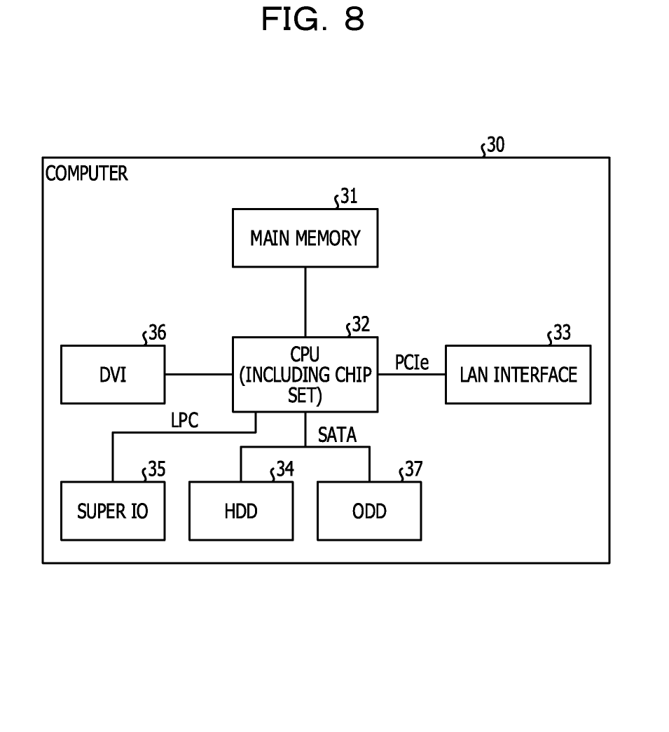

FIG. 8 illustrates an example of a hardware configuration of a computer. The computer illustrated in FIG. 8 may execute the replication program. As illustrated in FIG. 8, a computer 30 includes a main memory 31, a central processing unit (CPU) 32, a LAN interface 33, and a HDD 34. In addition, the computer 30 also includes a super input output (IO)) 35, a digital visual interface (DVI) 36, and an optical disk drive (ODD) 37.

The main memory 31 may be a memory that stores a program, a result in the middle of execution of the program, and the like. The CPU 32 may be a CPU that reads a program from the main memory 31 and executes the program. The CPU 32 may include a chip set including a memory controller.

The LAN interface 33 may be an interface that is used to couple the computer 30 to a further computer through a LAN. The HDD 34 may be a disk device that stores a program and data. The super IO 35 may be an interface that is used to perform connection of an input device such as a mouse and a keyboard. The DVI 36 may be an interface that is used to perform connection of a liquid crystal display device. The ODD 37 may be a device that performs read and write of a digital versatile disc (DVD).

The LAN interface 33 is coupled to the CPU 32 by PCI Express, and the HDD 34 and the ODD 37 are coupled to the CPU 32 by serial advanced technology attachment (SATA). The super IO 35 is coupled to the CPU 32 by low pin count (LPC).

The replication program that is executed in the computer 30 is stored in a DVD, read from the DVD by the ODD 37, and installed on the computer 30. For example, the replication program is stored in a database and the like of a further computer system that is coupled through the LAN interface 33, and is installed on the computer 30 so as to be read from the databases. The installed replication program is stored in the HDD 34, read to the main memory 31, and executed by the CPU 32.

The replication device may be included in the distribution storage. For example, even when the replication program is executed in a client or a computer that is in the vicinity of the client, the replication device may be applied in the similar manner.

The arrangement of a replica may be determined using a hash. For example, when arrangement servers are switched in order, the arrangement of a replica may be determined by a further method.

The replication device and a client may correspond to each other so as to be one to one. When “m” and “n” are set as given positive integers, the replication device and the client may correspond to each other so as to be “m” to “n”.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A replication device comprising:
a memory configured to store a replication program; and
a CPU configured to execute the replication program,
wherein the CPU, based on the replication program, performs operations:
determining an arrangement, as a first arrangement of a first replica of first data to a storage node, so that the first data are distributed and stored to and in a plurality of first storage nodes; and
determining an arrangement, as a second arrangement of a second replica of second data to the storage node, so that the second data is continuously stored in a second storage node that is different from the plurality of first storage nodes.

2. The replication device according to claim 1, further comprising:
an arrangement destination storage configured to store a first identifier for identifying the storage node of the first arrangement and the second arrangement; and
a last transmission destination storage configured to store a second identifier for identifying the storage node to which the first data or the second data is transmitted lastly,
wherein the CPU determines the second arrangement of the second replica to the second storage node based on the first identifier and the second identifier.

3. The replication device according to claim 2, wherein
the CPU selects a destination storage node of the second replica by calculating a hash value, and, when the storage destination node is different from the storage node of the second identifier, makes the destination storage node identical to the storage node of the second identifier by dividing a hash range that includes the hash value into a plurality of ranges.

4. The replication device according to claim 3, wherein
in a case in which the storage destination node does not become identical to the storage node of the second identifier when the hash range is divided by a certain number of times, the CPU determines to arrange the second replica to the storage destination node, and updates the storage node of the second identifier with the storage destination node.

5. The replication device according to claim 1, wherein
the CPU determines whether or not the data is to be read from an identical storage node, and determines reading of the data from the plurality of first storage nodes or the second storage node based on a determination result.

6. A replication method, comprising:
determining an arrangement, by a computer, as a first arrangement of a first replica of first data to a storage node, so that the first data are distributed and stored to and in a plurality of first storage nodes; and
determining an arrangement, as a second arrangement of a second replica of second data to the storage node, so that the second data is continuously stored in a second storage node that is different from the plurality of first storage nodes.

7. The replication method according to claim 6, further comprising:
storing a first identifier for identifying the storage node of the first arrangement and the second arrangement;
storing a second identifier for identifying the storage node to which the first data or the second data is transmitted lastly; and
determining the second arrangement of the second replica to the second storage node based on the first identifier and the second identifier.

8. The replication method according to claim 7, further comprising:
selecting a destination storage node of the second replica by calculating a hash value and,
making, when the storage destination node is different from the storage node of the second identifier, the destination storage node identical to the storage node of the second identifier by dividing a hash range that includes the hash value into a plurality of ranges.

9. The replication method according to claim 8, further comprising:
determining, in a case in which the storage destination node does not become identical to the storage node of the second identifier when the hash range is divided by a certain number of times, to arrange the second replica to the storage destination node; and
updating the storage node of the second identifier with the storage destination node.

10. The replication method according to claim 6, further comprising:
determining whether or not data is to be read from an identical storage node; and
determining reading of the data from the plurality of first storage nodes or the second storage node based on a determination result.

11. A replication system comprising:
a plurality of storage nodes; and
a replication device coupled to the plurality of storage nodes,
wherein the replication device performs operations of:
determining an arrangement, as a first arrangement of a first replica of first data to the plurality of storage nodes, so that the first data are distributed and stored to and in a plurality of first storage nodes of the plurality of storage nodes; and
determining an arrangement, as a second arrangement of a second replica of second data to the plurality of storage nodes, so that the second data is continuously stored in a second storage node of the plurality of storage nodes, the second storage node being different from the plurality of first storage nodes.

12. The replication system according to claim 11, wherein the plurality of storage nodes are servers.

13. The replication system according to claim 11, wherein the replication device includes:
an arrangement destination storage configured to store a first identifier for identifying the storage node of the first arrangement and the second arrangement; and
a last transmission destination storage configured to store a second identifier for identifying the storage node to which the first data or the second data is transmitted lastly,
wherein the CPU determines the second arrangement of the second replica to the second storage node based on the first identifier and the second identifier.

14. The replication system according to claim 13, wherein
the replication device selects a destination storage node of the second replica by calculating a hash value, and, when the storage destination node is different from the storage node of the second identifier, makes the destination storage node identical to the storage node of the second identifier by dividing a hash range that includes the hash value into a plurality of ranges.

15. The replication system according to claim 14, wherein
in a case in which the storage destination node does not become identical to the storage node of the second identifier when the hash range is divided by a certain number of times, the replication device determines to arrange the second replica to the storage destination node, and updates the storage node of the second identifier with the storage destination node.

16. The replication system according to claim 11, wherein
the replication device determines whether or not the data is to be read from an identical storage node, and determines reading of the data from the plurality of first storage nodes or the second storage node based on a determination result.
